(19) United States
(12) Patent Application Publication
(10) Pub. No.: US 2005/0217170 A1
(43) Pub. Date: Oct. 6, 2005

(54) Tree stand

(76) Inventor: Robert S. Reeves, Toronto (CA)

Correspondence Address: STIKEMAN ELLIOTT, 1600-50 O'CONNOR STREET, OTTAWA, ON, KIP LS2, CA

(21) Appl. No.: 11/030,957

(22) Filed: Jan. 10, 2005

Related U.S. Application Data
(60) Provisional application No. 60/558,585, filed on Apr. 2, 2004.

(51) Int. Cl. A01G 9/00

(52) U.S. Cl. 47/39

(57) ABSTRACT

A tree stand for holding a tree with a root ball in a container includes three elongated, tubular feet interconnected at one end and flaring outwardly at 120° to each other. The feet have open top ends and contain slides retained in the feet by stops at such top ends. Post assemblies including plates connected to the slides by bolts are mounted on the feet. The bolts can be loosened to permit longitudinal movement of the post assemblies on the feet and tightened to lock the post assemblies in any of a plurality of positions against the root ball container.

### BACKGROUND OF THE INVENTION

1. Field of the Invention

This invention relates to a tree stand, and in particular to a display stand for use in garden centers and nurseries.

2. Discussion of the Prior Art

Most garden centers that sell large trees, display balled and burlapped trees by healing them into mulch beds, while container grown trees are left freestanding in nursery yards. While mulch itself is relatively inexpensive, mulch beds are expensive, because mulch is costly to handle. For example dedicated equipment (i.e. equipment not otherwise used) is required for handling mulch beds. Front end or skid-steer loaders are used to position the mulch, heal-in trees, pull trees from the mulch when sold and to rework the mulch bed for new trees.

Mulch is messy and often drifts away from the bed area. Mulch beds restrict drainage, resulting in puddles, mud, algae and a breeding ground for mosquitoes. If a mulch bed is located in gravel, the gravel mixes with the mulch.

One of the biggest problems with mulch beds is that mulch decomposes. Typically, as the mulch begins to break down, mulch volume is lost, weeds begin to grow and the trees begin to take root in the mulch bed. When a tree is sold, newly emerged, fibrous roots have to be sheared off or re-covered with burlap for delivery and planting. If trees in mulch do not sell quickly enough they take root, and are inevitably damaged when removed from the mulch. Accordingly, nurseries regularly turn trees in order to snap off emerging roots. It is often necessary to re-burlap root balls, which have rotted in the mulch.

### GENERAL DESCRIPTION OF THE INVENTION

Obviously, for the above listed reasons and others, there is a need for a cost effective, neat manner for displaying and/or transporting nursery trees. An object of the present invention is to meet this need by providing a relatively simple tree stand, which is readily mass produced.

Another object of the invention is to provide a tree stand which is durable, easy to use and adjustable for supporting trees of different sizes.

Accordingly, the present invention relates to a tree stand for holding a tree with roots in a container comprising base means including at least three foot means, each said foot means having a first end connected to first ends of all other said foot means, whereby said foot means radiate outwardly from said first ends in a plane for stably supporting the stand on a horizontal surface; post means for mounting on each said foot means; and connector means for connecting said post means to said foot means, whereby the post means define a cage around sides of a tree container to maintain the tree in a vertical orientation.

### BRIEF DESCRIPTION OF THE DRAWINGS

A preferred embodiment of the invention is shown in the accompanying drawings, wherein:

FIG. 1 is a schematic, isometric view of a tree stand in accordance with the present invention;

FIG. 2 is a top view of a base used in the tree stand of FIG. 1;

FIG. 3 is a side view of a post assembly used in the stand of FIG. 1;

FIG. 4 is an end view of the post assembly of FIG. 3;

FIG. 5 is an isometric view of one side of the stand of FIG. 1 with parts omitted; and

FIG. 6 is a cross section taken generally along line 6-6 of FIG. 3.

### DESCRIPTION OF THE PREFERRED EMBODIMENT

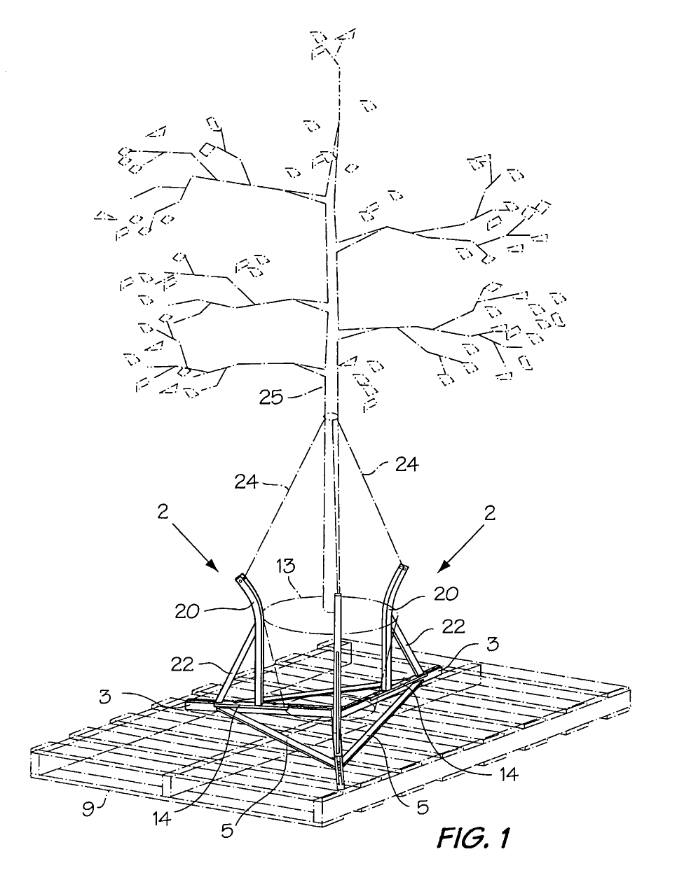

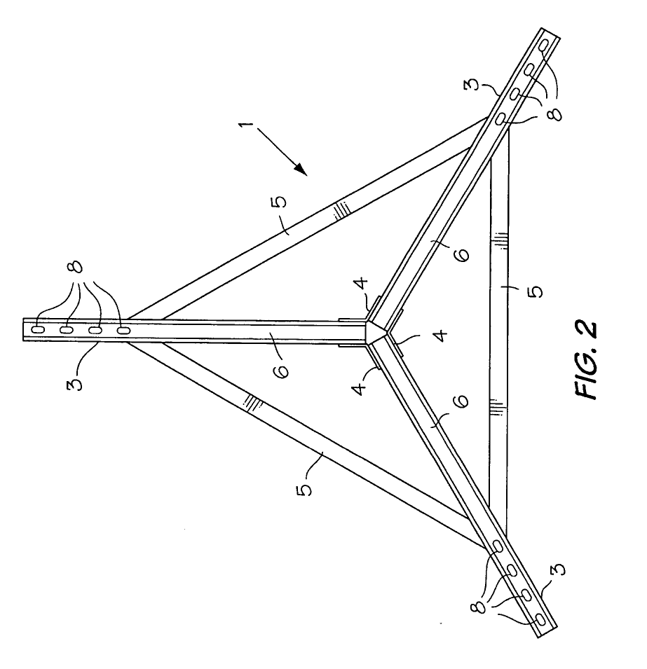

With reference to FIGS. 1 to 4, the principal elements of the stand include a base and a plurality of post assemblies indicated generally at 1 and 2, respectively. The base 1 is defined by three elongated feet 3, which are interconnected at one end by metal strips 4 welded to the ends of the feet and flat diagonal braces 5. The feet 3 are at 120° to each other which provides the greatest stability. However, the 120° angle between the feet is not critical. Each foot 3 is generally U-shaped in cross section including a bottom wall 6, and side walls 7. Slots 8 are provided near the outer ends of the bottom walls for receiving bolts, screws or ground anchor pins (not shown) for connecting the stand to a pallet 9 or other horizontal surface such as the ground. The top ends of the side walls are bent inwardly and downwardly to define flanges 10. The flanges 10 act as stops for retaining a slide 11 in the foot. The slides 11 form part of connectors for retaining the post assemblies in a fixed position against the sides of a tree container 13.

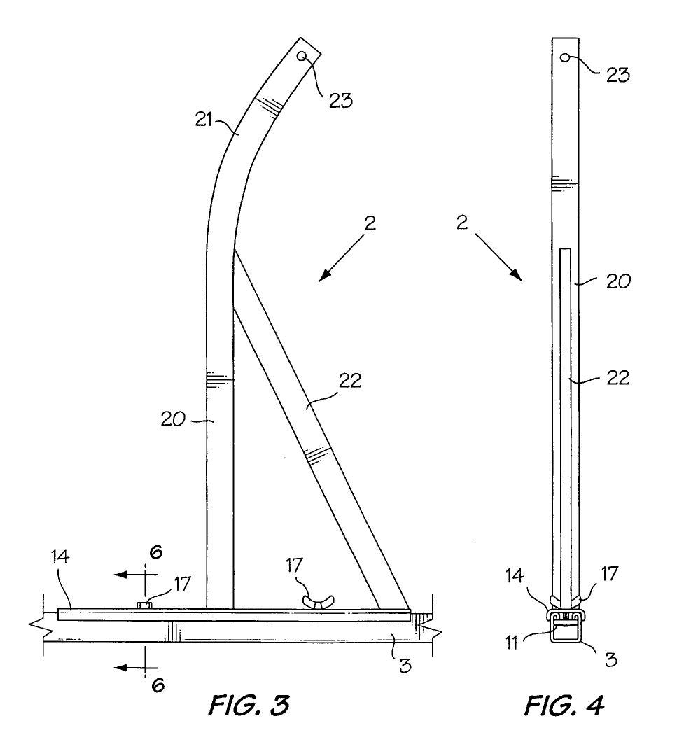

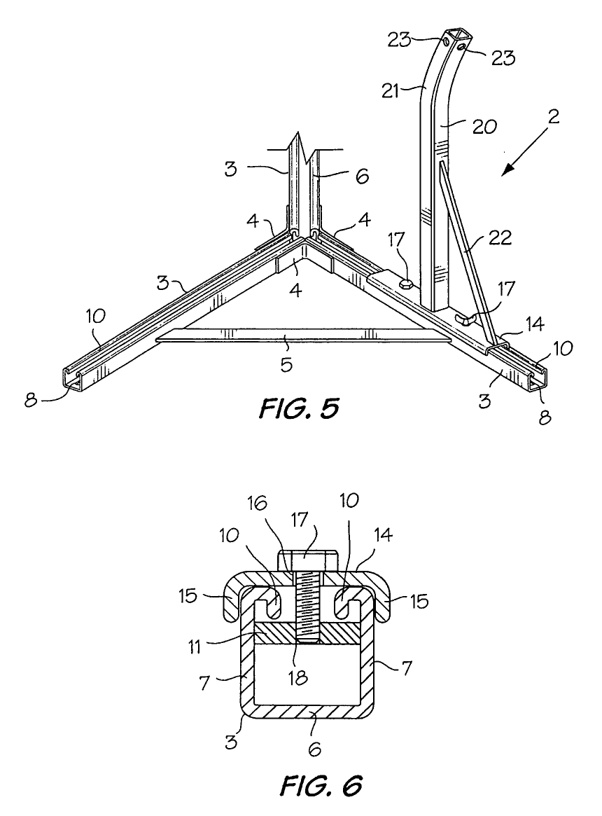

Each post assembly 2 includes a top plate 14 with downwardly extending sides 15 for resting on the open top end of a foot 3. A pair of spaced apart holes 16 in the plate 13 receive bolts 17 which can be machine bolts or wing bolts (one of each is shown in FIGS. 3 and 5). The slide 11 also includes a pair of threaded holes 18 (one shown—FIG. 5) aligned with the holes 16, whereby the slide is suspended from the bolts 17. When the bolts 17 are loose, the post assembly, i.e. the slide 11 and the plate 14 can be slid longitudinally of a foot 3. Because the outer end of the foot 3 is open, the slide 11 can be slid out of the foot. Thus, the post assemblies 2 can be quickly separated from the feet 3 for space efficient storage. When the bolts 17 are tightened, the slide 11 is drawn up against the downwardly extending flanges 10 of the foot side walls 7 to lock the post assembly 2 in position. By making the slides 11 sufficiently long, the post assemblies 2 can be secured in many different positions, even positions where the posts 20 are beyond the open ends of the feet 3. Thus, the stand can accommodate trees having root systems which are quite large.

A tubular post 20 with an arcuate top end 21 extends upwardly from the center of the top plate 14. A reinforcing brace 22 extends diagonally from one end of the top plate 14 to the post 20 above the middle thereof. A hole 23 is provided in each side of the post 20 near the top end thereof for receiving cords or cables 24 (FIG. 1) for tethering the trunk or the top of a tree 25. The holes 21 can receive eyebolts (not shown) for use when tethering a tree.

From the foregoing, it will be appreciated that the tree stand of the present invention can be lightweight, tough and stable even when on uneven surfaces. By using heavy gauge steel parts, which are welded together, and hot dip galvanizing the parts, rusting is prevented and the stand can last for years even in wet nursery conditions.

For storage, the post assemblies slide out of the feet. Moreover, the stands can be stacked and occupy very little space. The stands can be stacked alone or while attached to a standard pallet. In this manner the hundreds of pallets typically accumulated by garden centers can be put to good use. When two inch tubular steel is used for the feet and the feet are stored on pallets, the stands and the pallets form a stack just over five feet in height.

Rope is often used to bind wire baskets at the top of root balls. The rope is often wound tightly around the base of the tree trunk to keep the root ball stable. The binding may result in girdling of the trunk if a tree grows a significant amount before planting. The stand of the present invention permits loosening of the ropes. Tethering of the top of a tree to the tops of the posts replaces the support achieved by tightening the rope around the trunk.

Finally, the spacing of the feet to form angles of 120° between adjacent feet allows loading and unloading of heavy trees using a forklift only. It is no longer necessary to use chains or hooks, or awkward and dangerous manual lifting.

1. A tree stand for holding a tree with roots in a container comprising base means including at least three foot means, each said foot means having a first end connected to first ends of all other said foot means, whereby said foot means radiate outwardly from said first ends in a plane for stably supporting the stand on a horizontal surface; post means for mounting on each said foot means; and connector means for connecting said post means to said foot means, whereby the post means define a cage around sides of a tree container to maintain the tree in a vertical orientation.

2. The tree stand of claim 1, wherein each said post means includes a top plate for attachment to one said foot means, and a post connected to and extending upwardly from said top plate for engaging a side of a tree container.

3. The tree stand of claim 2, wherein each said post means includes a diagonal brace extending between said top plate and said post.

4. The tree stand of claim 2, wherein said connector means are adapted to releasably connect said post means to said feet means, whereby the positions of said post means on said base means can be changed for supporting tree containers of different sizes.

5. The tree stand of claim 4, wherein each said foot means includes an elongated tube having a bottom wall, side walls, an open top end and stops on the interior of said side walls proximate the upper ends thereof;
and said connector means includes a slide in said tube, and bolts connecting said slide to said top plate, whereby, when the bolts are loose, the slide and post means can be slid longitudinally of the tube and, when the bolts are tight, the slide is locked in position against said stops to retain the post means in one position on said foot means.

6. The tree stand of claim 5, wherein said tube has a second, open free end, whereby the slide and post means can be removed from said foot means.

7. The tree stand of claim 2, wherein each said post includes an arcuate top end and at least one hole in said top end for use when connecting the top of the post to a tree above the bottom thereof.

8. The tree stand of claim 5, including three said foot means interconnected at one end and flaring outwardly from said one end at 120° to each other.
